(19) United States
(12) Patent Application Publication
(10) Pub. No.: US 2013/0174348 A1
(43) Pub. Date: Jul. 11, 2013

(54) Dual Sided Comfort Sleep System

(71) Applicant: Jon Stowe, Plano, TX (US)

(72) Inventor: Jon Stowe, Plano, TX (US)

(21) Appl. No.: 13/345,282

(22) Filed: Jan. 6, 2012

(51) Int. Cl. A47C 23/04; B23P 11/00; A47C 17/00

(52) U.S. Cl. 5/720; 5/727; 29/428

(57) ABSTRACT

The present disclosure relates to a method of adjusting a mattress system for maximum comfort. Users can control the comfort level on their individual side of the Dual Sided Comfort Sleep System without compromising their desired comfort levels to accommodate their sleep partner. The disclosure is tailored to fit individual comfort needs based on a unique combination of comfort-pad inserts and mattress support system cores. The comfort-pad inserts and the mattress cores are both available in various materials that affect the comfort level of the mattress system. The disclosure consists of variable comfort-pad inserts resting atop a mattress system support core component which is then encased in a covering secured by a closing mechanism. The disclosure allows a consumer to adjust the firmness of the mattress to a plurality of varying comfort levels by changing comfort pad inserts and mattress support system cores.

### CROSS-REFERENCE TO RELATED APPLICATIONS

None

### TECHNICAL FIELD

The present disclosure is generally a mattress, and in particular, a mattress with adjustable inserts and mattress core material that provides different levels of firmness and cushioning for the mattress system.

### BACKGROUND

Mattress manufacturers have traditionally produced mattresses that consist of uniform materials and firmness throughout the product. Mattresses vary from very soft to very firm. Due to the variations in human bodies and preferences for comfort, it is unlikely that any pair of persons would desire the same firmness and support level in a mattress. Inevitably, one of the pair will likely have to compromise with regard to maximum comfort.

Preferences can vary based on weight, age, general health, any disabilities or diseases, circulation issues, or any variety of factors. As the human body ages and deteriorates, standards and conditions for comfort change as well. Additionally, sleeping patterns and habits also change as the human body ages. These factors all have an effect on what various persons perceive as comfortable at different stages throughout their lives.

As time passes on, traditional mattresses need to be replaced due to wear and continued use over the years. The traditional mattresses suffer from sagging and uneven wear due to repetitive use and inconsistent rotation and flipping. Additionally, as technology evolves, consumers are encouraged to invest in new bedding to maximize comfort. Current mattresses, frequently thicker and quilted to low-density foam, often fail due to body impressions in the quilted panel.

In the present disclosure, users can choose varying comfort-pad inserts for their respective sides of the mattress. In cases of malfunction or customer dissatisfaction, remedy will be much less expensive because the comfort-pads are the only components that need to be transported to the retail establishment or delivered to the home of the consumer. In addition, as the consumer ages and comfort needs change, the comfort-pad inserts can be exchanged to accommodate new preferences versus replacing the entire mattress system, which would be required with a traditional mattress. This option also makes this disclosure greener and environmentally friendlier as less waste is created when consumers want to change the feel of their bedding system. The outer cover lasts longer and degrades slower because the mattress is thin and smooth and therefore less susceptible to body impressions.

### SUMMARY

The present disclosure is an adjustable mattress system that can be placed upon a traditional box spring. The system does not force users to compromise on individual comfort needs because each party can customize the thickness and firmness of their side of the bed. When the time comes to change the comfort-pad inserts due to wear or change in preferences, the process is straightforward. The comfort level is readily modifiable by the consumer in the home. Or alternatively, the consumer can easily transport the inserts in their passenger vehicle to the retail establishment, unlike a traditional mattress system. Consumers can also control the cost of the system when they decide on the number of inserts to purchase. Consumers can also quickly adjust the comfort level for visitors and houseguests by swiftly changing the comfort-pad inserts to accommodate a particular guest's tastes.

The lower component of the system is a mattress support system core while the upper portion consists of removable comfort-pad inserts of varying thickness and firmness to cater to differences in comfort requirements for the parties sharing the mattress system. The mattress support system core and the comfort-pad inserts are enveloped inside a foam encasement with a closing mechanism, such as a zipper.

The mattress support system core is available in different materials that change the overall comfort level of the mattress system. The mattress support system core can be made of a) foam encased pocket coil, b) foam encased innerspring, c) foam encased soy foam, or d) latex. Unlike the comfort-pad inserts, the material chosen for the core will be consistent throughout the entire mattress support system core and cannot be varied for an individual user's side of the mattress support system.

The comfort-pad inserts are available in various thickness and firmness levels. The inserts can be positioned adjacent to other inserts and/or piled on top of other inserts. Regardless of the arrangement chosen by the consumer, the comfort-pad inserts can be enclosed in the foam encasement once placed upon the mattress support system core. Comfort-pad inserts for this disclosure are available in a variety of “Indentation Load Deflection” (ILD) levels. ILD is an industry term that measures foam firmness. a) Ultra Plush is achieved with 1.5 density foam with 15-23 ILD on bottom layer of insert, b) Medium Plush is achieved with 1.5 density foam 25-32 ILD, and c) Medium Firm is achieved with 1.5 density Foam 35-45 ILD. Comfort-pad inserts are also available in a variety of materials such as a) soy foam, b) soy foam and latex, and c) soy foam and memory foam (visco). Ultra Plush, Medium Plush, and Medium Firm are industry terms used in marketing descriptions of the above referenced density foam. These terms are samples of the different ILD and resulting firmness levels available for consumers of the present invention.

The mattress support system includes a mattress encasement that surrounds the comfort-pad inserts and mattress support system core. Once the desired comfort-pad inserts are chosen and arranged on the mattress support system core, the entire unit will be removably enclosed within the encasement. The mattress support system is then secured with a closing mechanism, such as a zipper, to secure the position of the comfort-pad inserts.

The disclosure is encased in a foam covering, which can be made of various other fabric materials. The encasement can be closed by zipper, as in the current embodiment. Other closure mechanisms, such as buttons, snaps, or hook and loop fasteners (Velcro), can also be used to close the encasement around the mattress support system core and comfort-pad inserts. The encasement serves a decorative as well as functional purpose.

### BRIEF DESCRIPTION OF THE DRAWINGS

FIG. 1 is front view of the entire Dual Sided Comfort Sleep System;

FIG. 1a is the mattress support system encased in foam encasement material;

FIG. 1b is the foam encasement material surrounding the comfort-pad inserts;

FIG. 1c is the zipper that secures the comfort-pad inserts inside of the foam encasement material;

FIG. 2 is a front view of a stack of several comfort-pad inserts;

FIG. 2a is a stack of the comfort-pad inserts of varying size, thickness, and density;

FIG. 3 is a close up image of a custom pad insert atop the mattress support system core, inside an unclosed encasement;

FIG. 3a is a single comfort-pad insert;

FIG. 3b is a zipper closing mechanism that secures the comfort-pad inserts inside of the foam encasement material;

FIG. 3c is the mattress support system core that supports the comfort-pad insert;

FIG. 4 is a close up image of the Dual Sided Comfort Sleep System, including the mattress support system core and the comfort pad inserts covered by the foam encasement material;

FIG. 4a is the foam encasement material that covers the mattress support system;

FIG. 4b is the zipper that secures the comfort-pad inserts inside of the foam encasement material and on top of the mattress support system;

FIG. 4c is the comfort-pad insert inside of foam encasement material encasing mattress system.

### DETAILED DESCRIPTION OF THE DRAWINGS

While the above description is of the preferred embodiment of the present invention, it should be appreciated that the invention may be modified, altered, or varied without deviating from the scope and fair meaning of the following claims.

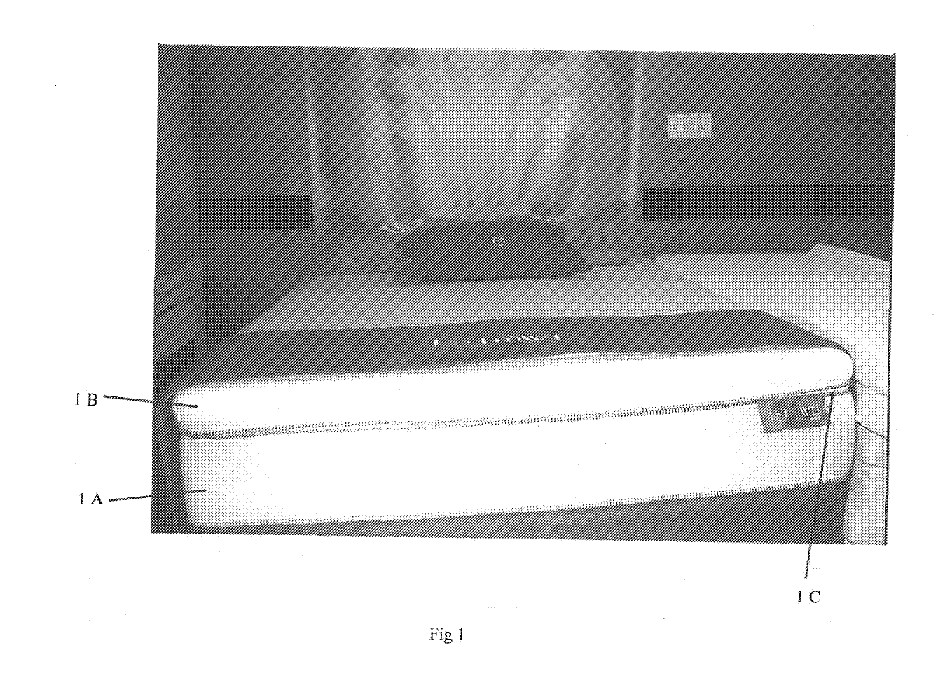

With reference to FIG. 1, this view is a full view of the assembled Dual Sided Comfort Sleep System. FIG. 1a is the mattress support system core enclosed by foam encasement material. The material used for the encasement can vary to suit the tastes of the consumer. Its measurements will depend on the standard size of the mattress system (full, queen, king). The material used for the encasement can vary to suit the tastes of the consumer. The mattress support system core is a mattress that can be placed on a traditional box spring. The mattress support system core can be made of a) foam encased pocket coil, b) foam encased innerspring, c) foam encased soy foam, or d) latex. Each of these core materials will change the comfort level experienced by the consumer. Unlike the comfort-pad inserts, the material chosen for the core cannot be varied for an individual user's side of the mattress support system. The core material is uniform throughout the Dual Sided Comfort Sleep System.

FIG. 1b is the comfort-pad inserts enclosed by foam encasement material. The comfort-pad inserts sit upon the mattress support system core. The comfort-pad inserts and the support system core are enclosed together in an encasement that surrounds the comfort-pad inserts and support system core with a closing mechanism, such as the zipper from FIG. 1c. The upper and lower layers of foam encasement material are attached by a zipper that closes the encasement around the mattress support system core and comfort-pad inserts. The zipper mechanism attaches the two pieces of encasement on all sides of the mattress support system core and comfort pad inserts. Other closing mechanisms can be used in place of a zipper such as buttons, snaps, hook and loop fasteners (Velcro) as well as a host of other closing mechanisms.

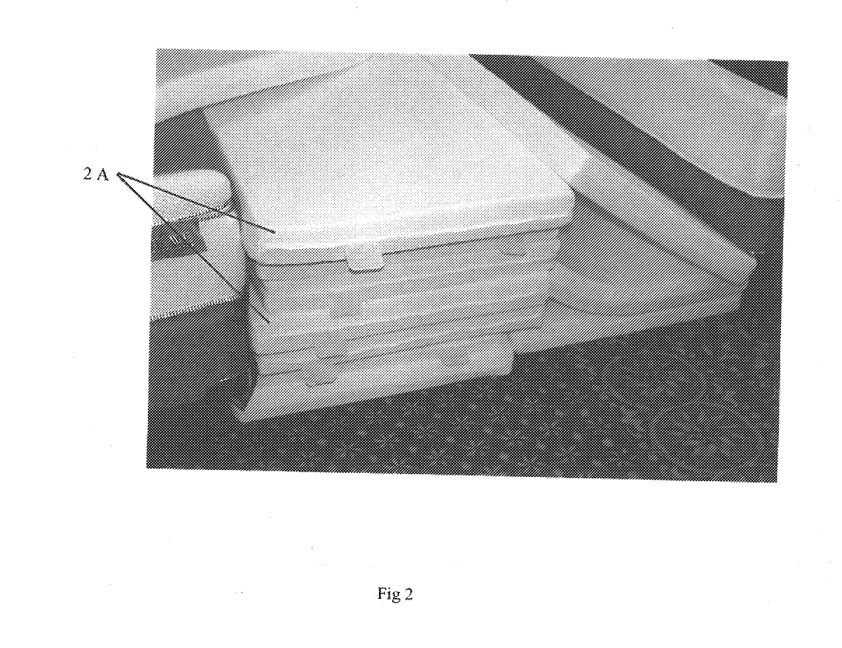

With reference to FIG. 2, this view is of various comfort-pad inserts available with this Dual Sided Comfort Sleep System. FIG. 2a is a stack of the comfort-pad inserts of varying size, thickness, and density. The comfort-pad inserts chosen by the consumer rest on the mattress support system core and are encased together in the foam covering. Users will each choose comfort-pads to achieve their desired thickness and firmness level. Users can also choose multiple pads to stack upon each other to achieve the desired comfort level on either side of the system. Once pads are chosen for each user, those comfort-pad inserts are placed on the mattress support system core. The mattress support system core and the desired comfort-pad inserts are then secured inside the foam encasement.

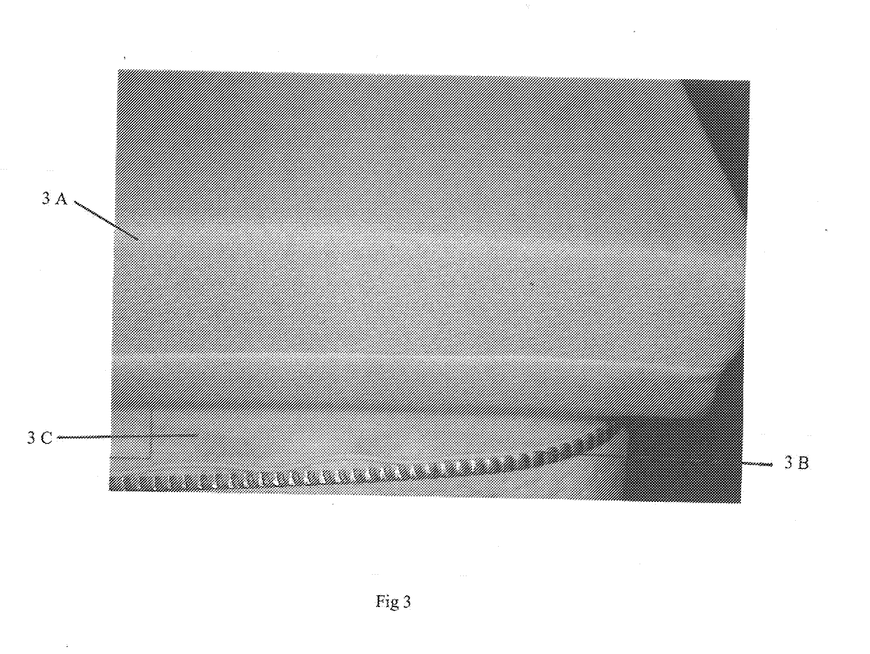

With reference to FIG. 3, this view is a close up image of a corner section of the Dual Sided Comfort Sleep System inside the encasement. FIG. 3a is a single comfort-pad insert. The user would choose a combination of comfort-pad inserts to accommodate their unique comfort and support level. The comfort-pad inserts chosen for each side of the mattress support system would be positioned side by side upon the mattress support system core before being enclosed within the foam covering. This exposed view shows FIG. 3a, a comfort-pad insert, atop. FIG. 3c, the mattress support system core. FIG. 3b is the zipper mechanism shown in an open position. FIG. 3b surrounds the entire mattress system and connects the foam material encasing the comfort-pad inserts and the foam material encasing the mattress support system core.

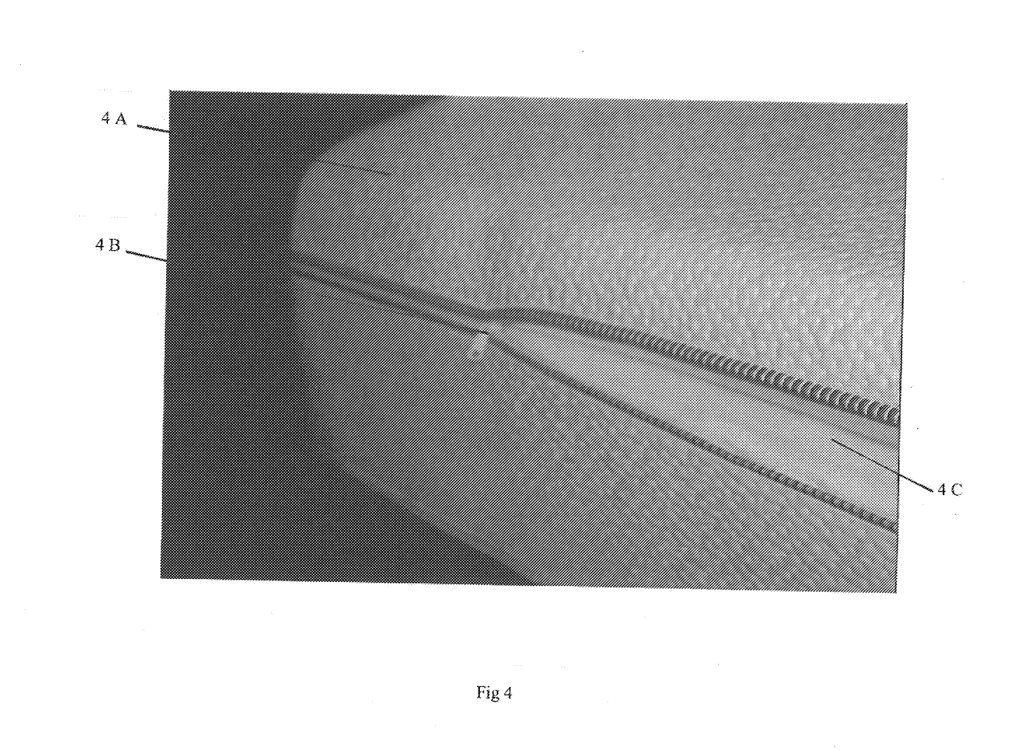

With reference to FIG. 4, this view is a close up image of a corner section of the Dual Sided Comfort Sleep System covered by the foam encasement material. FIG. 4a is the foam encasement material that encloses the mattress support system. The foam encasement lasts longer and degrades slower than the traditional mattress covering because the mattress beneath it is thinner and smoother and therefore less susceptible to body impressions than the traditional mattress. FIG. 4b is the zipper that encloses the comfort-pad inserts, resting upon the mattress support system core, inside of the foam encasement material. This embodiment describes a zipper as the closing mechanism but any variety of other fasteners would serve a similar purpose and accomplish the same goal of securing the custom-pad inserts upon the mattress support system core inside the encasement. FIG. 4c is a view of the comfort-pad insert inside of foam encasement material encasing mattress system.

What is claimed is:

1. An apparatus comprising a plurality of pads positioned longitudinally on a platform within an encasement, said encasement surrounding the combination of said pads atop said platform, wherein said encasement includes a closing mechanism, which when open, permits such pads to be placed on top of said platform on the interior of said encasement.

2. The apparatus of claim 1 wherein said platform is a mattress.

3. The apparatus of claim 2 wherein said mattress is made of material selected from the group consisting of: foam encased pocket coil, foam encased innerspring, foam encased soy foam, or latex.

4. The apparatus of claim 2 wherein said pad is made of material selected from the group consisting of: foam, soy foam, soy foam and latex, or soy foam and memory foam.

5. The apparatus of claim 3 wherein said pad is made of material selected from the group consisting of: foam, soy foam, soy foam and latex, or soy foam and memory foam.

6. The apparatus of claim 4 wherein said encasement is made of material selected from the group consisting of: foam and fabric.

7. The apparatus of claim 5 wherein said encasement is made of material selected from the group consisting of: foam and fabric.

8. The apparatus of claim 6 wherein said closing mechanism is selected from the group consisting of: a zipper, buttons, snaps, and hook and loop fasteners.

9. The apparatus of claim 7 wherein said closing mechanism is selected from the group consisting of: a zipper, buttons, snaps, and hook and loop fasteners.

10. A method of manually adjusting the comfort level of a mattress system comprising the steps of:
placing the lower portion of the encasement material upon a box spring, with the closing mechanism in an open position, said closing mechanism facing upward, and the exterior portion of said encasement upon said box spring;
choosing a mattress support system core material that results in a desirable comfort level for the consumer;
placing said chosen mattress support system core inside the lower portion of the encasement material;
choosing a primary combination of comfort-pad inserts that result in a desirable comfort level for the primary consumer;
placing a single stack of said comfort-pad inserts on top of a single side of said mattress support system core;
aligning the edge of said stack of comfort-pad inserts with the edge of said mattress support system core;
choosing a secondary combination of comfort-pad inserts that result in a desirable comfort level for the secondary consumer;
placing a single stack of said comfort-pad inserts on top of the alternate side of said mattress support system core;
aligning the edge of said secondary stack of comfort-pad inserts such that both sets of said comfort-pad inserts are aligned with opposing edges of said mattress support system core;
placing the upper portion of said encasement material on top both sets of said comfort pad inserts, with said closing mechanism in an open position, said closing mechanism facing downward, and the exterior portion of the upper portion of said encasement facing upward; and
securing said upper and lower portions of encasement to one another using said closing mechanism attached to said encasements.
